(19) United States
(12) Patent Application Publication
(10) Pub. No.: US 2017/0126569 A1
(43) Pub. Date: May 4, 2017

(54) ENHANCED NEIGHBOR DISCOVERY TO SUPPORT LOAD BALANCING

(71) Applicant: Convida Wireless, LLC, Wilmington, DE (US)

(72) Inventors: Dale N. SEED, Allentown, PA (US); Shamim Akbar RAHMAN, Quebec (CA); Chonggang WANG, Princeton, NJ (US); Lijun DONG, San Diego, CA (US); Quang LY, North Wales, PA (US)

(73) Assignee: Convida Wireless, LLC, Wilmington, DE (US)

(21) Appl. No.: 15/317,432

(22) PCT Filed: Jun. 12, 2015
(86) PCT No.: PCT/US2015/035559

§ 371 Date: Dec. 9, 2016

Related U.S. Application Data
(60) Provisional application No. 62/011,284, filed on Jun. 12, 2014.

(51) Int. Cl. H04L 12/803; H04L 12/24; H04L 29/12; H04W 4/00; H04L 29/08

(52) U.S. Cl. CPC H04L 47/125; H04W 4/008; H04L 67/12; H04W 4/005; H04L 61/2069; H04L 41/0806

(57) ABSTRACT

The present application is direct to a method and apparatus for creating a load-balancing group. The method includes a step of determining to create a load balancing group on a router. The method also includes a step of sending a ND ICMP message to the router including a load balancing configuration extension. Further, the method includes a step of receiving a ND ICMP message from the router including an anycast address related to the load balancing configuration extension. The present application also is directed to a method and apparatus of discovering a load-balancing group.

### CROSS-REFERENCE TO RELATED APPLICATIONS

This application claims priority from U.S. Provisional Patent Application No. 62/011,284, filed Jun. 12, 2014, the disclosure of which is incorporated herein by reference in its entirety.

### BACKGROUND

Ineffective methods for load balancing traffic within Internet of Things (IoT) type networks often causes resource constrained network devices to become overloaded and saturated. That is, incoming packets targeting either a specific IoT device or requesting packets to be forwarded from the IoT device to another upstream or downstream device can be compromised. This is primarily attributed to IoT devices having some combination of limited battery power, limited processing power, small memory footprint and low throughput links.

Presently, the task of load balancing traffic across similar types of devices—those which are generally functional equivalents—within IoT networks rests in the hands of applications or higher layer protocols. Independent applications, however, have little or no awareness of other applications. As such, they are unable to effectively coordinate an appropriate load balance of network devices. On the other hand, higher level protocols, such as HTTP or CoAP, presently do not have the capacity to load balance requests across a group of functionally equivalent IoT devices. Even further, DNS based load balancing involves additional components such as a server and a network administrator.

In the field of networking, IPv6 and 6LoWPAN neighbor discovery (ND) protocol are employed for making next-hop routing decisions. These are layer three (3) protocols that support single-hop routing of traffic, such as for example IP datagrams, between network nodes. Next-hop routing decisions allow packets of data to be transferred from a router to the next closest router in its routing path.

Conventional ND protocols do not support load balancing. This may be attributed to their ND protocol employing out-of-band methods of assigning anycast addresses to network nodes. Namely, these nodes require manual configuration by an application, a user or a network administrator. As such, these methods may be undesirable for resource constrained, unmanned devices with little or no network management or administration.

In addition, current ND protocols are not capable of load balancing IP traffic across a group of devices having the same anycast IP address. In this case, all packets targeting the anycast address are routed to a single device instead of being load balanced across devices all having the same anycast address. By so doing, the single network device receiving all of the packets may quickly become overloaded.

### SUMMARY

This summary is provided to introduce a selection of concepts in a simplified form that are further described below in the Detailed Description. This Summary is not intended to limit the scope of the claimed subject matter. The foregoing needs are met, to a great extent, by the present application directed to a process and apparatus for load balancing packets among plural nodes in a network.

One aspect of the application is directed to a computer-implemented method of creating a load-balancing group. The method may include a step of determining to create a load balancing group on a router. In addition, the method may include a step of sending a ND Internet Control Message Protocol (ICMP) message to the router including a load balancing configuration extension. The method also may include a step of receiving a ND ICMP message from the router including an anycast address related to the load balancing configuration extension. Further, the method may include configuring the anycast address in order to receive packets from the router targeting the anycast address. In one embodiment, the load balancing configuration extension may be selected from one or more of the following: a load balancing tag, a load balancing anycast address, a load balancing requirement, a load balancing policy, and a load balancing state.

Another aspect of the application is directed to an endpoint device including a non-transitory memory having instructions stored thereon for creating a load balancing group. The endpoint device may also include a processor, operatively coupled to the memory, wherein the processor may be configured to perform the instructions of: (i) sending a ND ICMP message to the router including a load balancing configuration extension; and (ii) receiving a ND ICMP message from the router including an anycast address related to the load balancing configuration extension. In one embodiment, the endpoint device may include a transceiver.

In yet another aspect of the application, there is described a computer-implemented method of discovering a load balancing group. The method may include the step of providing a node and a router. The method may also include the step of receiving a load balancing variable extension including a load balancing group from the router. In addition, the method may include the step of determining whether to join the load balancing group. In one embodiment, the method further may include the step of sending a message including a load balancing configuration extension to the router. In another embodiment, the method may include a step of receiving a ND ICMP message from the router including an anycast address. In a further embodiment, the method may include the step of configuring the anycast address in order to receive packets from the router targeting the anycast address.

In even a further aspect of the application, there is described a computer-implemented method of discovering a load balancing group. The method may include the step of providing a node and a router and sending a solicitation to a router including a load balancing query extension. The method may also include the step of receiving a load balancing context extension including an available load balancing group. In addition, the method may include the step of determining whether to join the available load balancing groups. The method may also include the step of sending a load balancing configuration extension. Further the method may include the step of receiving a ND ICMP message from the router including an anycast address related to the load balancing configuration extension. In an embodiment, the method may also include the step of sending a message to the router with load balancing details of which load balancing group to join. In another embodiment, the method may include the step of configuring the anycast address in order to receive packets from the router targeting the anycast address.

There has thus been outlined, rather broadly, certain aspects of the application in order that the detailed description thereof may be better understood, and in order that the present contribution to the art may be better appreciated. There are, of course, additional aspects of the application that will be described below and which will form the subject matter of the claims appended hereto.

### BRIEF DESCRIPTION OF THE DRAWINGS

In order to facilitate a fuller understanding of the application, reference is now made to the accompanying drawings, in which like elements are referenced with like numerals. These drawings should not be construed as limiting the application and are intended only to be illustrative.

FIG. 1A illustrates a system diagram of an example machine-to-machine (M2M) or Internet of Things (IoT) communication system in which one or more disclosed embodiments may be implemented.

FIG. 1B is a system diagram of an example architecture that may be used within the M2M/IoT communications system illustrated in FIG. 1A.

FIG. 1C is a system diagram of an example M2M/IoT terminal or gateway device that may be used within the communications system illustrated in FIG. 1A.

FIG. 1D is a block diagram of an example computing system in which aspects of the communication system of FIG. 1A may be embodied.

FIG. 2 illustrates a neighbor discovery load balancing message format.

FIG. 3 illustrates load balancing variables according to a Time-Length-Value (TLV) format.

FIG. 4 illustrates an IP datagram load balancing routing tag.

FIG. 5 illustrates a load balancing aware next-hop determination algorithm.

FIG. 6 illustrates a method for an endpoint device to create a load balancing group.

FIG. 7 illustrates a method for a router to create a load balancing group.

FIG. 8 illustrates a method for a solicited discovery and joining of a load balancing group.

FIG. 9 illustrates a method for an unsolicited discovery and joining of a load balancing group.

FIG. 10 illustrates a method of forwarding packets according to a load balanced neighbor discovery next-hop determination.

### DETAILED DESCRIPTION OF THE ILLUSTRATIVE EMBODIMENTS

A detailed description of the illustrative embodiments will now be discussed in reference to various figures, embodiments and aspects herein. Although this description provides a detailed example of possible implementations, it should be noted that the details are intended to be examples and in no way limit the scope of the application.

Reference in this specification to “one embodiment,” “an embodiment,” “one or more embodiments,” or the like means that a particular feature, structure, or characteristic described in connection with the embodiment is included in at least one embodiment of the disclosure. Moreover, the term “embodiment” in various places in the specification is not necessarily referring to the same embodiment. That is, various features are described which may be exhibited by some embodiments and not by the other.

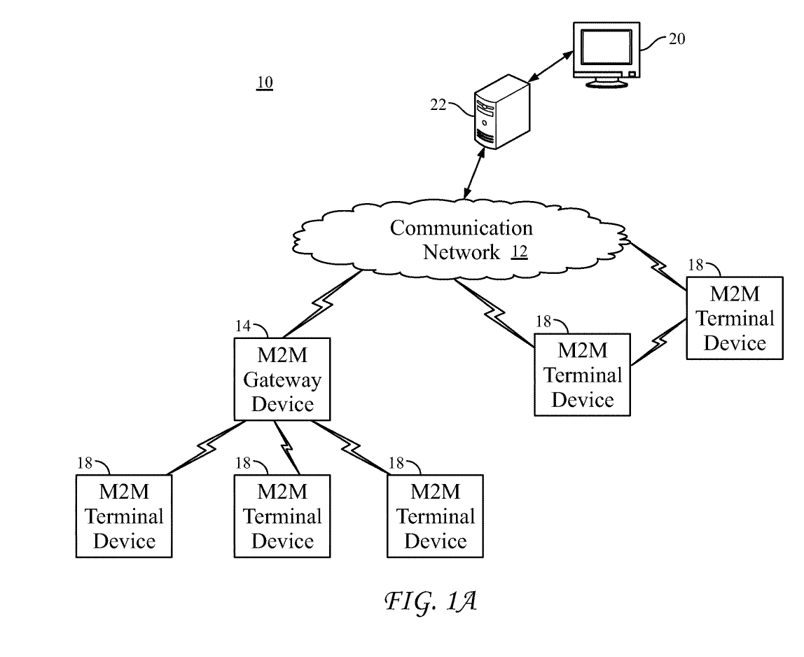

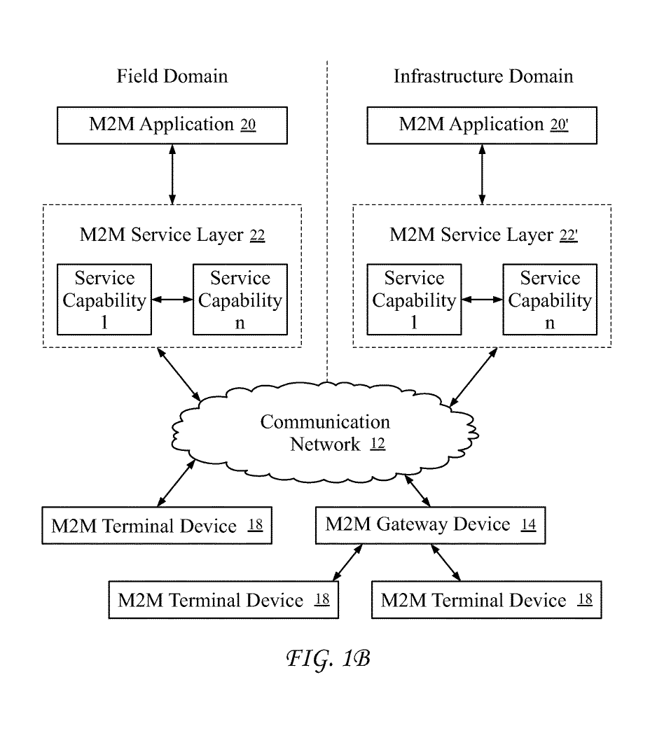

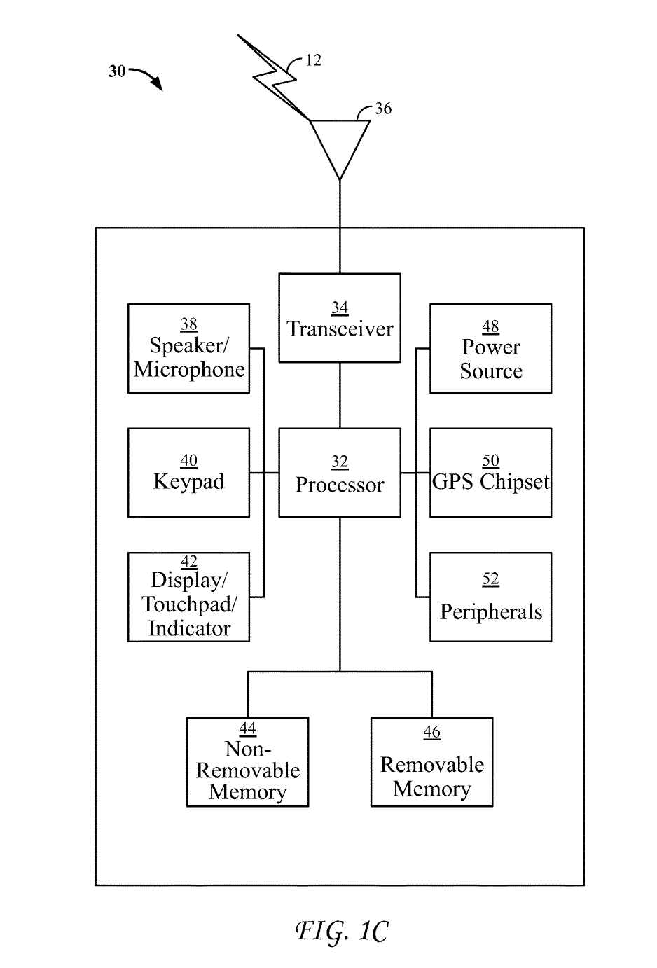

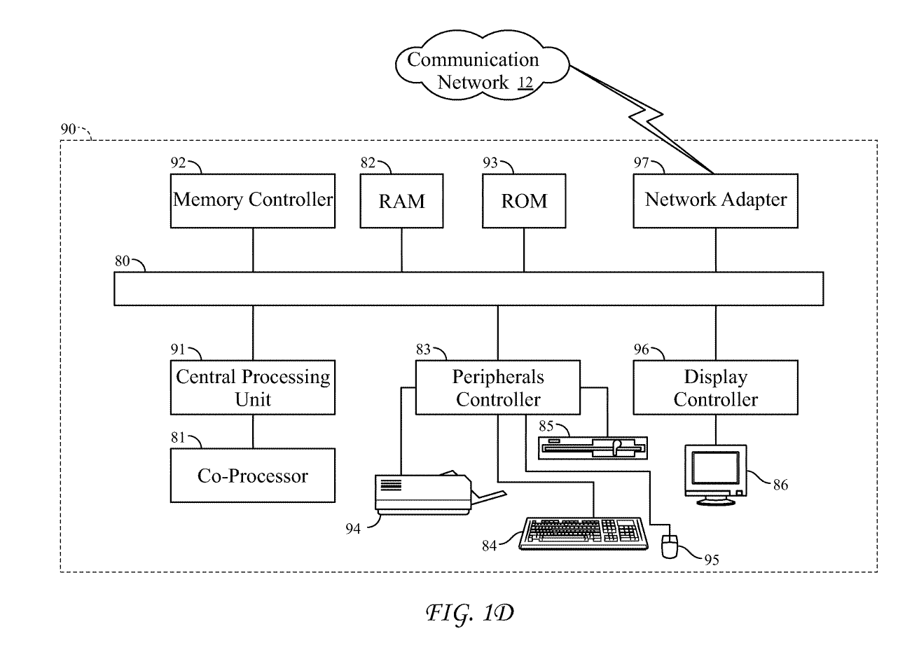

The present application describes new extensions to the IPv6 and 6LoWPAN neighbor discovery (ND) protocols to support load balancing of IP traffic targeting nodes, including Internet of Things (IoT) and M2M endpoint devices and IoT and M2M routers, present in an IoT or M2M network, such as the example networks described below and illustrated in FIGS. 1A-1D. The new extensions to the IPv6 and 6LoWPAN Neighbor Discovery protocol may include but are not limited to architecture for creating load balancing groups, architecture for discovering and joining load balancing groups, and architecture for determining the next-hop for packets.

6LoWPAN ND optimizes the IPv6 ND aimed at low-power and lossy networks such as 6LoWPAN based networks. For example, 6LoWPAN eliminates multicast-based address resolution operations for devices and promotes device-initiated interactions to accommodate sleepy devices. 6LoWPAN also optimizes the address registration option (ARO) extension. That is, endpoint devices are allowed to register their addresses to routers with a specified registration lifetime. Routers no longer need to perform address resolution using Neighbor Solicitation (NS) and Neighbor Advertisement (NA) messages.

In particular, the instant application provides a set of ND load balancing variables that are used to maintain load balancing information for individual nodes as well as load balancing groups. Moreover, the application provides a definition of a new ND Load Balancing Cache to maintain group-specific load balancing state for each load balancing group. Also, the application provides a definition of ND Neighbor Cache extensions to support maintaining node-specific load balancing state for neighboring nodes. Further, the application provides a definition of methods for extending ICMP messages used by the ND protocol to support the proposed ND load balancing variables.

The application also includes a definition of ND load balancing protocol extensions. For example, the extensions may include but are not limited to an extension to allow IoT devices to query for routers that support load balancing capabilities and/or specific types of load balancing groups; an extension to allow IoT nodes to exchange the state of load balancing variables or updated load balancing requirements with one another; an extension to allow IoT nodes to configure load balancing variables of other IoT nodes; and an extension to allow IoT nodes to subscribe to receive notifications from other IoT nodes if and when changes to load balancing variables occur.

This application is intended to cover both platform functionality and support for both application enablement platforms (AEPs) and connected device platforms (CDPs). AEPs include an application enablement layer and a service layer including the World Wide Web and Internet. The application enablement layer includes but is not limited to the following: (i) servicing APIs, rules/scripting engine; (ii) SDK programming interface; and (iii) enterprise systems integration. The application enablement layer may also include value-added services including but not limited to discovery, analytics, context and events. The service layer including the world wide web and Internet may comprise, for example, analytics, billing, raw APIs, web service interfaces, semantic data models, device/service discovery, device management, security, data collection, data adaptation, aggregation, event management, context management, optimized connectivity and transport, M2M gateway, and addressing and identification. The CDPs may include connectivity analysis, usage analysis/reporting/alerts, policy control, automated provisioning, SIM activation/deactivation, and subscription Activation/Deactivation.

Prior to discussing the methods and apparatuses of this application in full detail, a brief description of the general architecture will be provided. FIG. 1A is a diagram of an example machine-to machine (M2M), Internet of Things (IoT), or Web of Things (WoT) communication system 10 in which one or more disclosed embodiments may be implemented. Generally, M2M technologies provide building blocks for the IoT/WoT, and any M2M device, gateway or service platform may be a component of the IoT/WoT as well as an IoT/WoT service layer, etc.

As shown in FIG. 1A, the M2M/IoT/WoT communication system 10 includes a communication network 12. The communication network 12 may be a fixed network, e.g., Ethernet, Fiber, ISDN, PLC, or the like or a wireless network, e.g., WLAN, cellular, or the like, or a network of heterogeneous networks. For example, the communication network 12 may comprise of multiple access networks that provides content such as voice, data, video, messaging, broadcast, or the like to multiple users. For example, the communication network 12 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. Further, the communication network 12 may comprise other networks such as a core network, the Internet, a sensor network, an industrial control network, a personal area network, a fused personal network, a satellite network, a home network, or an enterprise network for example.

As shown in FIG. 1A, the M2M/IoT/WoT communication system 10 may include the Infrastructure Domain and the Field Domain. The Infrastructure Domain refers to the network side of the end-to-end M2M deployment, and the Field Domain refers to the area networks, usually behind an M2M gateway. The Field Domain includes M2M gateways 14, such as routers that configure requests from devices, and terminal devices 18, for example, which create new load balancing groups. It will be appreciated that any number of M2M gateway devices 14 and M2M terminal devices 18 may be included in the M2M/IoT/WoT communication system 10 as desired. Each of the M2M gateway devices 14 and M2M terminal devices 18 are configured to transmit and receive signals via the communication network 12 or direct radio link. The M2M gateway device 14 allows wireless M2M devices, e.g., cellular and non-cellular as well as fixed network M2M devices, e.g., PLC, to communicate either through operator networks, such as the communication network 12 or direct radio link. For example, the M2M devices 18 may collect data and send the data, via the communication network 12 or direct radio link, to a M2M application 20 or M2M devices 18. The M2M devices 18 may also receive data from the M2M application 20 or an M2M device 18. Further, data and signals may be sent to and received from the M2M application 20 via an M2M service layer 22, as described below. In one embodiment, the service layer 22. M2M devices 18 and gateways 14 may communicate via various networks including, cellular, WLAN, WPAN, e.g., Zigbee, 6LoWPAN, Bluetooth, direct radio link, and wireline for example.

Referring to FIG. 1B, the illustrated M2M service layer 22 in the field domain provides services for the M2M application 20, M2M gateway devices 14, and M2M terminal devices 18 and the communication network 12. It will be understood that the M2M service layer 22 may communicate with any number of M2M applications, M2M gateway devices 14, M2M terminal devices 18 and communication networks 12 as desired. The M2M service layer 22 may be implemented by one or more servers, computers, or the like. The M2M service layer 22 provides service capabilities that apply to M2M terminal devices 18, M2M gateway devices 14 and M2M applications 20. The functions of the M2M service layer 22 may be implemented in a variety of ways. For example, the M2M service layer 22 could be implemented in a web server, in the cellular core network, in the cloud, etc.

Similar to the illustrated M2M service layer 22, there is the M2M service layer 22′ in the Infrastructure Domain. M2M service layer 22′ provides services for the M2M application 20′ and the underlying communication network 12′ in the infrastructure domain. M2M service layer 22′ also provides services for the M2M gateway devices 14 and M2M terminal devices 18 in the field domain. It will be understood that the M2M service layer 22′ may communicate with any number of M2M applications, M2M gateway devices and M2M terminal devices. The M2M service layer 22′ may interact with a service layer by a different service provider. The M2M service layer 22′ may be implemented by one or more servers, computers, virtual machines, e.g., cloud/compute/storage farms, etc., or the like.

Referring also to FIG. 1B, the M2M service layer 22 and 22′ provide a core set of service delivery capabilities that diverse applications and verticals can leverage. These service capabilities enable M2M applications 20 and 20′ to interact with devices, such as one or more end-point devices and/or routers, and perform functions such as data collection, data analysis, device management, security, billing, service/device discovery etc. Essentially, these service capabilities free the applications of the burden of implementing these functionalities, thus simplifying application development and reducing cost and time to market. The service layer 22 and 22′ also enables M2M applications 20 and 20′ to communicate through various networks 12 and 12′ in connection with the services that the service layer 22 and 22′ provide.

The M2M applications 20 and 20′ may include applications in various industries such as, without limitation, transportation, health and wellness, connected home, energy management, asset tracking, and security and surveillance. As mentioned above, the M2M service layer, running across the devices, gateways, and other servers of the system, supports functions such as, for example, data collection, device management, security, billing, location tracking/geo-fencing, device/service discovery, and legacy systems integration, and provides these functions as services to the M2M applications 20 and 20′.

The method of creating a load-balancing group as discussed in the present application may be implemented as part of a service layer. The service layer is a software middleware layer that supports value-added service capabilities through a set of Application Programming Interfaces (APIs) and underlying networking interfaces. ETSI M2M's service layer is referred to as the Service Capability Layer (SCL). The SCL may be implemented within an M2M device (where it is referred to as a device SCL (DSCL)), a gateway (where it is referred to as a gateway SCL (GSCL)) and/or a network node (where it is referred to as a network SCL (NSCL)). The one M2M service layer supports a set of Common Service Functions (CSFs), e.g., service capabilities. An instantiation of a set of one or more particular types of CSFs is referred to as a Common Services Entity (CSE) which can be hosted on different types of network nodes, e.g., infrastructure node, middle node, application-specific node. Further, the method of creating a load-balancing group as described in the present application can implemented as part of an M2M network that uses a Service Oriented Architecture (SOA) and/or a resource-oriented architecture (ROA) to access services such as the reserving a track according to the present application.

FIG. 1C is a system diagram of an example M2M device 30, such as an M2M terminal device 18 or an M2M gateway device 14 for example. The terminal device may be an end-point device desiring to join a load-balancing group. The gateway device may be a router for maintaining a load balancing group. As shown in FIG. 1C, the M2M device 30 may include a processor 32, a transceiver 34, a transmit/receive element 36, a speaker/microphone 38, a keypad 40, a display/touchpad/indicator 42, non-removable memory 44, removable memory 46, a power source 48, a global positioning system (GPS) chipset 50, and other peripherals 52. It will be appreciated that the M2M device 40 may include any sub-combination of the foregoing elements while remaining consistent with an embodiment. This device may be a device that uses the disclosed systems and methods for embedded semantics naming of sensory data.

The processor 32 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 32 may perform signal coding, data processing, power control, input/output processing, and/or any other functionality that enables the M2M device 30 to operate in a wireless environment. The processor 32 may be coupled to the transceiver 34, which may be coupled to the transmit/receive element 36. While FIG. 1C depicts the processor 32 and the transceiver 34 as separate components, it will be appreciated that the processor 32 and the transceiver 34 may be integrated together in an electronic package or chip. The processor 32 may perform application-layer programs, e.g., browsers, and/or radio access-layer (RAN) programs and/or communications. The processor 32 may perform security operations such as authentication, security key agreement, and/or cryptographic operations, such as at the access-layer and/or application layer for example.

The transmit/receive element 36 may be configured to transmit signals to, or receive signals from, an M2M service platform 22. For example, in an embodiment, the transmit/receive element 36 may be an antenna configured to transmit and/or receive RF signals. The transmit/receive element 36 may support various networks and air interfaces, such as WLAN, WPAN, cellular, and the like. In an embodiment, the transmit/receive element 36 may be an emitter/detector configured to transmit and/or receive IR, UV, or visible light signals, for example. In yet another embodiment, the transmit/receive element 36 may be configured to transmit and receive both RF and light signals. It will be appreciated that the transmit/receive element 36 may be configured to transmit and/or receive any combination of wireless or wired signals.

In addition, although the transmit/receive element 36 is depicted in FIG. 1C as a single element, the M2M device 30 may include any number of transmit/receive elements 36. More specifically, the M2M device 30 may employ MIMO technology. Thus, in an embodiment, the M2M device 30 may include two or more transmit/receive elements 36, e.g., multiple antennas, for transmitting and receiving wireless signals.

The transceiver 34 may be configured to modulate the signals that are to be transmitted by the transmit/receive element 36 and to demodulate the signals that are received by the transmit/receive element 36. As noted above, the M2M device 30 may have multi-mode capabilities. Thus, the transceiver 34 may include multiple transceivers for enabling the M2M device 30 to communicate via multiple RATs, such as UTRA and IEEE 802.11, for example.

The processor 32 may access information from, and store data in, any type of suitable memory, such as the non-removable memory 44 and/or the removable memory 46. The non-removable memory 44 may include random-access memory (RAM), read-only memory (ROM), a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the M2M device 30, such as on a server or a home computer.

The processor 32 may receive power from the power source 48, and may be configured to distribute and/or control the power to the other components in the M2M device 30. The power source 48 may be any suitable device for powering the M2M device 30. For example, the power source 48 may include one or more dry cell batteries, e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which is configured to provide location information, e.g., longitude and latitude, regarding the current location of the M2M device 30. It will be appreciated that the M2M device 30 may acquire location information by way of any suitable location-determination method while remaining consistent with an embodiment.

The processor 32 may further be coupled to other peripherals 52, which may include one or more software and/or hardware modules that provide additional features, functionality and/or wired or wireless connectivity. For example, the peripherals 52 may include an accelerometer, an e-compass, a satellite transceiver, a sensor, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1D is a block diagram of an exemplary computing system 90 on which, for example, the M2M service platform 22 of FIG. 1A and FIG. 1B may be implemented. Computing system 90 may comprise a computer or server and may be controlled primarily by computer readable instructions, which may be in the form of software, wherever, or by whatever means such software is stored or accessed. Such computer readable instructions may be executed within central processing unit (CPU) 91 to cause computing system 90 to do work. In many known workstations, servers, and personal computers, central processing unit 91 is implemented by a single-chip CPU called a microprocessor. In other machines, the central processing unit 91 may comprise multiple processors. Coprocessor 81 is an optional processor, distinct from main CPU 91 that performs additional functions or assists CPU 91. CPU 91 and/or coprocessor 81 may receive, generate, and process data related to the disclosed systems and methods for embedded semantic naming, such as queries for sensory data with embedded semantic names.

In operation, CPU 91 fetches, decodes, and executes instructions, and transfers information to and from other resources via the computer's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memory devices coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 can be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode can access only memory mapped by its own process virtual address space; it cannot access memory within another process's virtual address space unless memory sharing between the processes has been set up.

In addition, computing system 90 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. Display 86 may be implemented with a CRT-based video display, an LCD-based flat-panel display, gas plasma-based flat-panel display, or a touch-panel. Display controller 96 includes electronic components required to generate a video signal that is sent to display 86. Display 86, may display sensory data in files or folders using embedded semantics names. Further, computing system 90 may contain network adaptor 97 that may be used to connect computing system 90 to an external communications network, such as network 12 of FIG. 1A and FIG. 1B.

According to the present application, it is understood that any or all of the systems, methods and processes described herein may be embodied in the form of computer executable instructions, e.g., program code, stored on a computer-readable storage medium which instructions, when executed by a machine, such as a computer, server, M2M terminal device, M2M gateway device, or the like, perform and/or implement the systems, methods and processes described herein. Specifically, any of the steps, operations or functions described above may be implemented in the form of such computer executable instructions. Computer readable storage media include volatile and nonvolatile, removable and non-removable media implemented in any method or technology for storage of information, but such computer readable storage media do not includes signals. Computer readable storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other physical medium which can be used to store the desired information and which can be accessed by a computer.

### Protocols

The neighbor discovery protocols employed in this application will now be discussed in detail. 6LoWPAN is a version of the IPv6 networking protocol suitable for resource constrained IoT devices. That is, 6LoWPaN Neighbor Discovery (ND) is an optimized version of IPv6 neighbor discovery targeted for use in 6LoWPAN based networks. For purposes of this application network nodes are considered to be endpoint devices or routers unless expressly stated otherwise. These network nodes use IPv6 ND to determine the link layer addresses for neighbors and to quickly purge cached values that become invalid. Network nodes may employ the ND protocol to keep track of which neighbor nodes are reachable and which are not. The ND protocol may also assist in detecting changed link-layer addresses. As such, the ND protocol may be considered a single-hop routing and discovery protocol.

The IPv6 ND protocol defines five different ICMP packet types. These are router solicitation (RS), router advertisement (RA), neighbor solicitation (NS), neighbor advertisement (NA) and redirect. RS is a request to a router to generate a RA immediately instead of at its next predetermined time. RA is an advertisement of its presence together with various link and network parameters either periodically or in response to a RS. RAs include prefixes that are used for determining whether another address shares the same link (on-link determination) and/or address configuration, a suggested hop limit value, etc. A NS is sent by a node to determine the link-layer address of a neighbor, or to verify that a neighbor is still reachable via a cached link-layer address. A NS is also used for Duplicate Address Detection (DAD). A NA is a response to a NS. A node may also send unsolicited NAs to announce a link-layer address change. A redirect is used by routers to inform an endpoint device of a better first hop for a destination.

The IPv6 ND also defines the following data structures maintained by nodes including for example, neighbor cache, destination cache, prefix list, default router list and node configuration variables. Each will be discussed in turn. Neighbor cache is used to maintain a set of entries of neighbors to which traffic has recently been sent. Entries are used to store information, including but not limited to, a neighbor's link-layer address, whether the neighbor is a router or an endpoint device, a pointer to any queued packets waiting for completing address resolution, reachability state. The destination cache is used to maintain a set of entries about destinations to which traffic has recently been sent. Entries map a destination IP address to the IP address of the next-hop neighbor. Entries are updated with information learned from Redirect messages. The prefix list is a list of the prefixes that define a set of addresses that are on-link. The default router list is a list of routers discovered during RS. These routers may have packets forward to it by a node. Node configuration variables are a set of variables used for configuration of node.

IPv6 ND also includes Neighbor Unreachability Detection and Next-Hop Determination algorithms. The Neighbor Unreachability Detection module helps support detecting the failure of sending packets to neighboring nodes that are no longer reachable and determining the next-hop to which a packet should be forwarded.

Further, the IPv6 ND protocol defines a set of ICMP message types. ICMP messages are carried in the payload of an IP packet. ICMP messages have an 8-byte header and a variable size data payload. For example, the first 4 bytes of the ICMP header is consistent across all ICMP message types, while the second 4 bytes of the header can vary based on the type of ICMP message. The ICMP Type field is used to specify the type of ICMP message. The Code field is used to indicate a sub-type of the given ICMP message. The Checksum is used for error checking and contains a checksum that is computed across the header and payload of the ICMP message. Currently ICMP message Types 0-41 are assigned to existing ICMP messages and 42-255 are reserved for future ICMP messages.

As disclosed herein, an IPv6 anycast address is an address that is assigned to more than one interface with the property that a packet sent to an anycast address is routed to the “nearest” interface having that address, according to the routing protocols' measure of distance. Anycast addresses are allocated from the unicast address space, using any of the defined unicast address formats. Thus, anycast addresses are syntactically indistinguishable from unicast addresses. When a unicast address is assigned to more than one interface, thus turning it into an anycast address, the nodes to which the address is assigned must be explicitly configured to know that it is an anycast address.

Neighbor Discovery handles anycasts by having nodes expect to receive multiple Neighbor Advertisements (NAs) for the same target address. All NAs for anycast addresses are tagged as being non-Override advertisements. A non-Override advertisement is one that does not update or replace the information sent by another Neighbor Advertisements. This is done so that when multiple NAs are received, the first received advertisement is maintained by the receiving node rather than the most recently received advertisement. By using the first advertisement, packets will be routed to the nearest node having the anycast address supported on one of its advertised interfaces.

According to one embodiment of the application, a node can support one or more load balancing variables as provided in Table 1 below. These proposed load balancing variables can be configured locally by the node or remotely by other nodes in the network. Local configuration of load balancing variables can be done using ND specific functionality and/or by interfacing between the ND protocol and other protocols or applications hosted on a node (e.g., MAC layer protocol, CoAP layer protocol, applications, etc). Remote configuration can be done using the proposed ND message extensions proposed in this disclosure.

The ‘NDLoadBalancingTag’ disclosed in Table 1 is used to define and enable the formation of a load balancing group. For example, this variable may include information of functional description of a node such as temperature, pressure, humidity, etc. Alternatively, this variable can be configured to a manufacturer-based description of a node, such as for example, make, model, serial number, etc. The variable may also be a location-based description of a node including, for example, geo-location, network domain, etc. In one embodiment, this variable may be used by a ND router to autonomously detect a group of temperature sensors made by the same manufacturer having the same model number. This variable may also be used by IoT devices to autonomously detect IoT routers of a particular type (routers supporting load balancing capability).

An IoT node may also be pre-provisioned with (i.e., have pre-stored within a memory of the node) one or more supported load balancing tags when it is manufactured or when it is deployed in the field. An IoT node can also publish its tags as well as discover the tags of other nodes in the network via the methods proposed in this disclosure. One IoT node can also create a new tag on another IoT node. For example, an IoT device can create a tag on an IoT router in order to create a new load balancing group which can be discovered and joined by other IoT devices. To help facilitate interoperability and the use of a common set of load balancing tags (e.g., Temperature, Pressure, Humidity, etc) between nodes of different manufacturers, a registry of standardized load balancing tags can be created by an industry body (e.g., IANA).

Moreover, load balancing tags can be encoded in various formats (e.g., TLV, Attribute Value Pair (AVP, etc.).

The ‘NDLoadBalancingAnycastAddress’ may be used to store the anycast address assigned to an IoT node and that is used to load balance packets to the node as well as any other nodes assigned with the same address (e.g., it is the address of a ND load balancing group). This address can be pre-provisioned into an IoT node when it is manufactured or when it is deployed. Alternatively this address can be dynamically configured within a node using the load balancing methods defined in this disclosure. The dynamic allocation of an anycast address can leverage the IPv6 auto-address generation and duplicate address detection mechanisms supported by IPv6 ND. Load balancing extensions to the ND next-hop determination algorithm can also be enabled via this proposed variable (e.g., as inputs to load balancing policies which can then be used to make load balancing decisions such as which IoT device to select and forward a given incoming packet to).

The ‘NDLoadBalancingRequirements’ variable can include, but is not limited to the following types of information: (i) Min Time Between Packets (the Minimum time between packets required by a node to process a packet (inter-packet time)); and (ii) Max Group Size (only join a load balancing group if it has less than a certain number of members). The IoT node can also further qualify each of the above requirements with additional stipulations, such as for example, energy/battery levels of a receiving node. For example, the Minimum time between packets increases as a nodes battery level decreases. Further, the identification of the originating node is factored (for example, to ensure there is a minimum time between two successive packets from the same node). It is envisaged that load balancing requirements may be encoded in various formats (e.g., TLV, AVP, etc). Via the methods proposed in this disclosure, these requirements can be published, discovered and stored by nodes.

The ‘NDLoadBalancingPolicies’ variable can be used by an IoT node to convey the type of load balancing policies it supports when distributing packets across a group of nodes. This variable can alternatively be used to convey the type of desired load balancing policy a node wishes other nodes to use when forwarding packets to it. Load balancing policies may include, for example, (i) Round-robin; (ii) Weighted round-robin; (iii) Energy-aware round robin; and (iv) Sleep aware load balancing. Weighted round-robin is a load balancing policy where different nodes can be configured with different weights. Weights can also be automatically generated. For example, nodes having load balancing requirements that specify larger minimum times between packets can be given lower weights. On the other hand, Energy-aware round robin is a load balancing policy where energy context can be shared between nodes using ‘NDLoadBalancingState’ variable. This energy context can then be factored into round-robin load balancing decisions. For example, nodes with higher levels of energy can be given higher priority. Further, Sleep-aware load balancing is a load balancing policy which takes into account the sleep state of a node when load balancing packets across a group of nodes. It is envisaged that Load balancing policies can also be encoded in various formats (e.g., TLV, AVP, etc).

The ‘NDLoadBalancingState’ variable can be used by a node to convey and/or discover load balancing state of itself and/or its neighboring nodes. Load balancing extensions to the ND next-hop determination algorithm can also be enabled via this proposed variable. For example, inputs to load balancing policies may be used to make load balancing decisions such as which IoT device to select and forward a given incoming packet to. LoadBalancingState may include, but is not limited to: (i) a list of load balancing group(s) a node has currently joined; (ii) a list or number of nodes that are members of a particular load balancing group; (iii) timestamps of when a packet was last forwarded to each load balancing group member; (iv) number of outstanding packets being processed for each neighborNode and/or network context information that can be used to further qualify load balancing forwarding decisions to a neighboring node (e.g., neighbor's current battery level, network congestion levels, etc); (iv) transaction history such as the order in which past packets have been forwarded to individual member nodes of the load balancing group; (v) remaining lifetime of load balancing group; (vi) availability of a node—whether or not a node is currently connected to the network or a node's availability schedule. It is envisaged the load balancing state can be encoded in various formats (e.g., TLV, AVP, etc). Load balancing state can also be encoded to compact the information and reduce overhead of messages. The set of load balancing state that is to be exchanged between nodes can be discovered and/or negotiated when a node joins a load balancing group.

TABLE 1

| Load Balancing Variables | Description |
|---|---|
| NDLoadBalancingTag | Serves as a descriptive identifier used to define and |
| | enable the formation of a load balancing group. A load |
| | balancing group may include functionally similar nodes. |
| NDLoadBalancingAnycastAddress | Used to store the anycast address assigned to an IoT |
| | node and that is used to load balance packets to the |
| | node as well as any other nodes assigned with the same |
| | address (e.g., it is the address of a ND load balancing |
| | group). |
| NDLoadBalancingRequirements | Used to define a node's load balancing requirements. |
| NDloadBalancingPolicies | Used by a node to convey the type of load balancing |
| | policies it supports when distributing packets across a |
| | group of nodes and/or to convey the type of desired |
| | load balancing policy a node wishes other nodes to use |
| | when forwarding packets to it. |
| NDLoadBalancingState | Used by a node to convey and/or discover load |
| | balancing state of itself and/or its neighboring nodes. |
| | Load balancing extensions to the ND next-hop |
| | determination algorithm may also be enabled by this |
| | variable. |

According to another embodiment, there is described a ND Load Balancing Cache function within an IoT node configured to store group-specific load balancing information in addition to node specific load balancing information. The information can be based upon the variables provided in Table 1. This information can be used to keep track of collective load balancing information for load balancing groups separate from individual nodes. It is noted that storing policies at an endpoint device can be used for upstream device-to-router load balancing, while storing policies at a router can be used for both upstream and downstream load balancing of packets. Also discussed are proposed enhancements to the ND Neighbor Cache for enhanced support of anycast based addressing. Specifically, there is capability to support the creation of Neighbor Cache entries for multiple ND Advertisements/Solicitations received from neighboring nodes having a common anycast address. As discussed above, conventional arts only disclose a single Neighbor Cache entry that is maintained for a given anycast address, which limits load balancing capabilities of the ND protocol.

The IPv6 and 6LoWPAN ND protocols also define a Destination Cache data structure. The Destination Cache maps a destination IP address to the IP address of the next-hop neighbor. Load balancing information can be stored in Destination Cache entries. This disclosure proposes extending the Destination Cache structure to support storing load balancing variables such as those in Table 1. In doing so, the use of Destination Cache entries can be qualified by the state of load balancing variables.

In another embodiment, the IPv6 and 6LoWPAN ND protocols also define a Default Router List data structure. The Default Router List maintains a list of available routers which a node discovers by sending Router Solicitations and receiving corresponding Router Advertisements. Each entry in this list contains information for a router such as its IP address. Additional information can be stored in Default Router List entries such as load balancing capabilities of a router (supported load balancing policies, groups, etc) and the variables proposed in Table 1. In doing so, the use of Default Router List entries can be qualified by load balancing variables. For example, upon an endpoint device selecting an upstream router to register itself to, the endpoint device can factor in the router's load balancing capabilities (e.g., choose a router that supports load balancing over one that does not).

### ND ICMP Load Balancing Messages

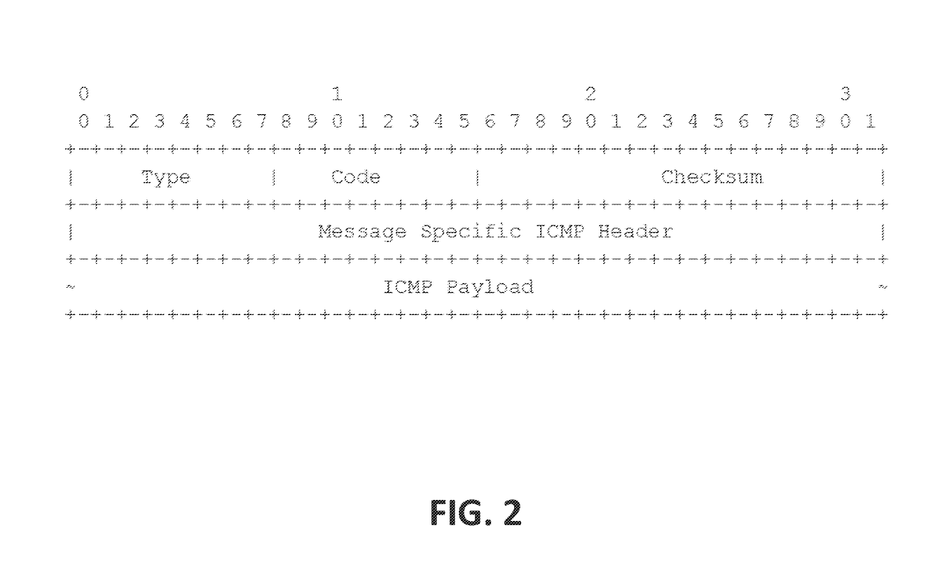

The present application includes multiple ways to extend the current set of ND ICMP message types to support the exchange of load balancing information between nodes. One way is by defining new ICMP load balancing message types. New ND load balancing ICMP message types can be defined by reserving an unused ICMP message type in the range of 42-255 with the LANA ICMP message registry. This message type is encoded in the 8-bit ‘Type’ field of the ICMP message header shown in FIG. 2. Each new ND load balancing ICMP message defined can also support one or more message subtypes using the ‘Code’ field of the ICMP message header as well as the 4-bytes of ICMP message specific header (using the upper 4-bytes of the ICMP 8 byte header). The data payload of each new message can be tailored to the message. For example, new load balancing ICMP message types can be defined for exchanging load balancing state, configuration of load balancing parameters of a node (e.g., its anycast address, its policies, etc), and subscription and notification to changes in load balancing state.

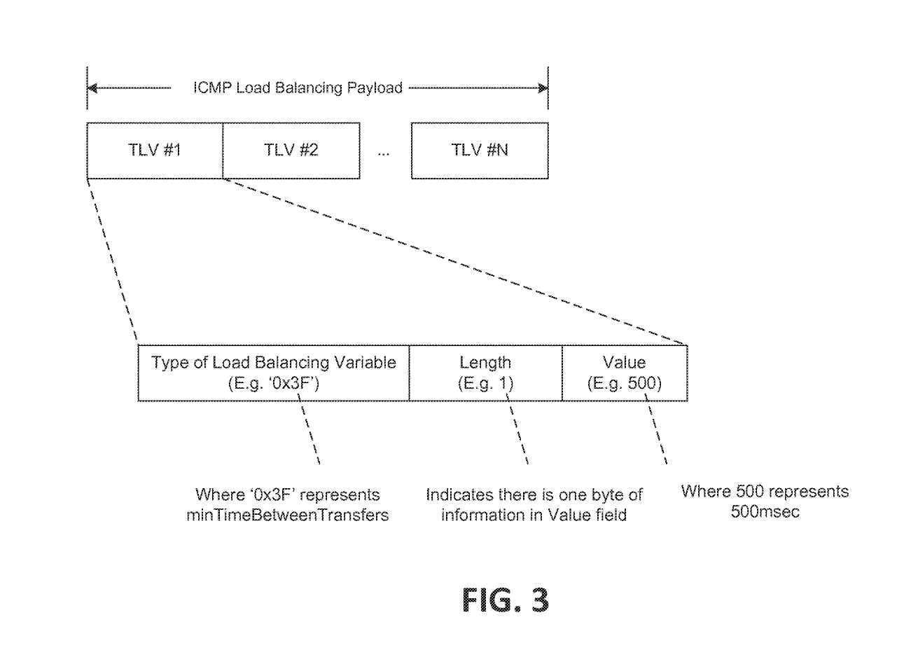

Even further, for example, a new ICMP message type can be defined to exchange and/or discover load balancing variables between neighboring nodes by reserving an ICMP message type in the available range of 42-255 of the 8-bit ICMP ‘Type’ field. The ICMP message payload can be used to carry the actual load balancing variable values. Load balancing variable values can be represented in the payload using one of several possible formats. For example, load balancing variables can be encoded using TLV (Type-Length-Value) triple where each variable can be represented by a pre-defined Type field specifying a unique identifier for each load balancing variable, a length defining the number of bytes contained within the corresponding value field, and a value field containing value of the variable. Note, this value can also be encoded as well. For example, a variable may support values between 0-100, where this number represents a percentage such as battery level. A single ICMP message payload may contain a single load balancing variable value or may contain several variables. In this case, multiple TLVs can be concatenated together in series within the payload. Alternatively, ICMP messages can carry a single load balancing variable. In this case the load balancing variable type can optionally be carried in either the ICMP ‘Code’ field or the 4-bytes of ICMP specific header rather than the payload. FIG. 3 shows how multiple load balancing variables may be encoded in TLVs concatenated within the payload of an ICMP message payload.

In an alternative embodiment, new subtypes for existing ICMP message types are defined. New ICMP message subtypes can be defined by reserving an ICMP message code (via the LANA registry) that is currently not in use for an existing ICMP message type. Each ICMP message can support up to 255 different subtypes. For example, one or more new subtypes can be added to the existing NA ICMP message type to support the exchange of load balancing variables. Within these existing ICMP messages and using these new load balancing sub-types, load balancing variables can be carried using similar methods such as the TLV-based ICMP payload as proposed above in FIGS. 2 and 3.

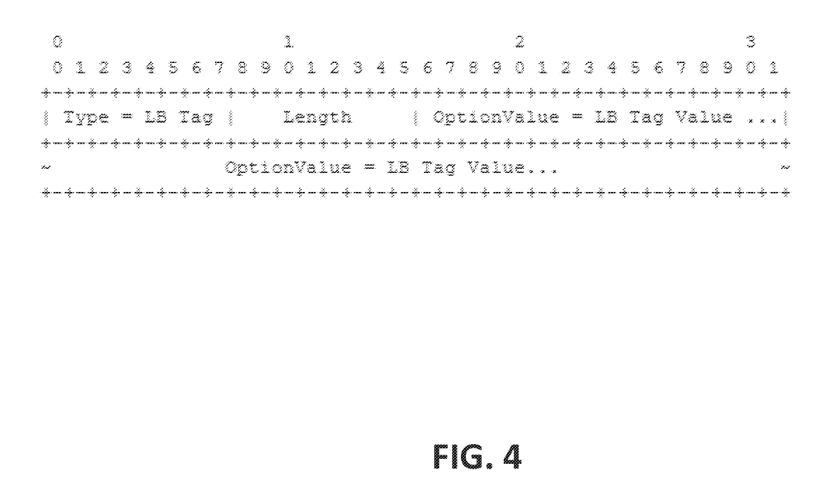

In yet another embodiment as shown in FIG. 4, the ND protocol defines a generic Type-Length-Value (TLV) based option that can be included in the payload of existing ICMP ND messages. For example load balancing options can be carried in Routing Advertisement and Solicitation messages as well as Neighbor Advertisement and Solicitation messages. Each ND message supports a set of respective options defined by the ND protocol. The TLV based option format as defined as shown in FIG. 4. The Type field is an 8-bit unique identifier for the option. The Length is an 8-bit field that stores the length of the TLV in bytes. The Value is a variable length field depending on the option type. New ND load balancing options can be supported by defining new unique identifiers for each Type of load balancing option along with corresponding defined Lengths and Values. For example, each of the load balancing variables proposed in Table 1 could be carried in existing ND ICMP messages by defining respective ND load balancing option types. Alternatively, multiple load balancing variables could be supported within a single ND load balancing option having a defined structure to carry multiple load balancing variables.

Note that, in other embodiments, other message types other than ICMP as well as other protocols (e.g., SNMP) can also be used to exchange and/or configure load balancing information that can then be used by the ND protocol.

This disclosure proposes ND load balancing query extensions to ND ICMP messages that can be used to specify a query string within an ND ICMP message containing one or more load balancing attribute value pairs. These attribute value pairs can be based on load balancing variables such as those proposed in Table 1 of this disclosure as well as others. This proposed query extension can be used within a RS message or NS message to allow an IoT node to query and find one or more neighboring nodes that support one or more desired load balancing capabilities (e.g., a particular load balancing group, a particular load balancing policy, etc) or to advertise a node's load balancing requirements and/or capabilities to its neighbors.

For example, when a router receives a RS ND message (e.g., from an endpoint device) with a load balancing query string it can use it to qualify whether or not it responds back with a RA. This qualification may be performed by comparing load balancing attribute value pairs in the query string against the load balancing capabilities/state of the router. If a match occurs, the router can respond with a routing advertisement, otherwise, the router can silently ignore the solicitation or forward it to another router in the network for it to process. For example, to find a router that supports round-robin load balancing capability, a query string such as ‘NDLoadBalancingPolicies==RoundRobin’ can be used in a Router Solicitation (RS) message.

In another embodiment, there are disclosed ND load balancing variable extensions that can be used to embed load balancing variable information within ND ICMP messages. That is, load balancing variables can be embedded by the sender in ICMP ND messages and be advertised to other nodes in the network. Recipient nodes may employ this information to discover load balancing nodes in the network. Recipient nodes may also detect nodes that are requesting other nodes to load balance messages on their behalf. Accordingly, nodes may maintain an awareness of neighboring nodes capable of performing load balancing as well as exchange load balancing state with other nodes in the network, and also make corresponding load balancing-aware adjustments. For example, a node can use the ND load balancing variable extension to specify its NDLoadBalancingTag within an ND ICMP message. The message may be a RS or NS sent to its neighboring nodes. In another example, a node can update its neighboring nodes of a change in its load balancing requirements and or state if/when its battery level drops below a certain threshold. This can be done by including the NDLoadBalancingRequirements or NDLoadBalancingState variables within an ND ICMP message.

In a further embodiment, ND load balancing configuration extensions may be used to specify load balancing configuration parameters for recipients of ND ICMP messages. This extension can support configuration of one or more load balancing variables in Table 1. Accordingly, a node receiving an ND ICMP message with a load balancing configuration extension can be used to configure corresponding ND load balancing variables on the node.

For example, a router can include a configuration extension within a Router Advertisement message it sends in order to configure the anycast address of an IoT device with the specific anycast address for load balancing. The anycast address can be one in which a router has allocated for a particular load balancing group which the IoT device has been added as a member. Alternatively, for example, an IoT device can configure a router with a new load balancing tag in order to create a new load balancing group which other IoT devices can discover from the router and in turn join. By creating a load balancing tag and associated group on a router which other IoT devices can discover and join, a router can support forwarding of packets to these devices in a load balance aware fashion. This forwarding can be further implemented by including the load balancing tag within an IP datagram which can be used by routers to effectively route and load balance the datagram across the nodes belonging to a corresponding load balancing group. Alternatively, a router can suggest and/or instruct a node to join a load balancing group or automatically add a device to a load balancing group.

In another embodiment, ND load balancing subscription and notification extensions to ND messages may be used to subscribe to a node and receive notifications from a node based on the occurrence of a specified ND load balancing condition or event (e.g., change in ND load balancing requirement, policy, state, etc). The load balancing subscription extension can support including subscription requests within ND ICMP messages. The subscription extension can include one or more targeted load balancing variables such as the load balancing variables proposed along with corresponding criteria for when a notification should be generated. A load balancing notification extension can support including notifications within ND ICMP messages. A notification can include event information such as which ND load balancing variables have changed state, their new values, etc.

For example, when using a load balancing subscription extension within a RA, a router can subscribe to receive load balancing notifications from nodes in the network each time their load balancing requirements change in a certain manner. This can be achieved by including a load balancing subscription criteria in the subscription extension included in the RA. As a result, nodes can generate a load balancing notification to the router each time their load balancing requirements change. Based on these notifications, a load balancing router can efficiently maintain up to date load balancing requirements of its neighboring node's and use this information to more effectively forward packets in a load balanced fashion.

According to yet another embodiment, ND load balancing router collaboration extensions to ND messages may be used by routers to share load balancing information with one another, e.g., exchange load balancing groups, state, policies, etc. The load balancing router collaboration extension can include one or more targeted load balancing variables such as the load balancing variables proposed in Table 1. For example, using a load balancing router collaboration extension within a RA message, a router can coordinate with other nearby routers to align their supported load balancing groups. Routers can also exchange load balancing state and align their load balancing policies as well. Routers can factor load balancing state from other routers into their load balancing decisions. For example, if two routers are able to forward packets to the same endpoint device, they can coordinate their load balancing decisions with one another.

In yet even another embodiment, a load balancing tag field may be applied to an IP datagram. This load balancing tag field can be used to perform tag-based routing. In addition this tag field can be configured with the NDLoadBalancingTag variable. Thus, IP datagrams can be routed by ND router nodes to nodes that are members of a ND load balancing group. In an exemplary embodiment, the tag field can be carried as an option in an IP datagram by defining a new IP option type for carrying load balancing tag. When a router receives an IP datagram having the proposed load balancing tag option, it can use this tag to index its Neighbor cache to determine whether a load balancing group exists for this tag. If so, it determines whether any devices are members of this group. If so, the router can forward this IP datagram to one of the devices based on the router's load balancing policies for this group.

### Load Balancing Extensions to ND Next-Hop Determination Algorithm

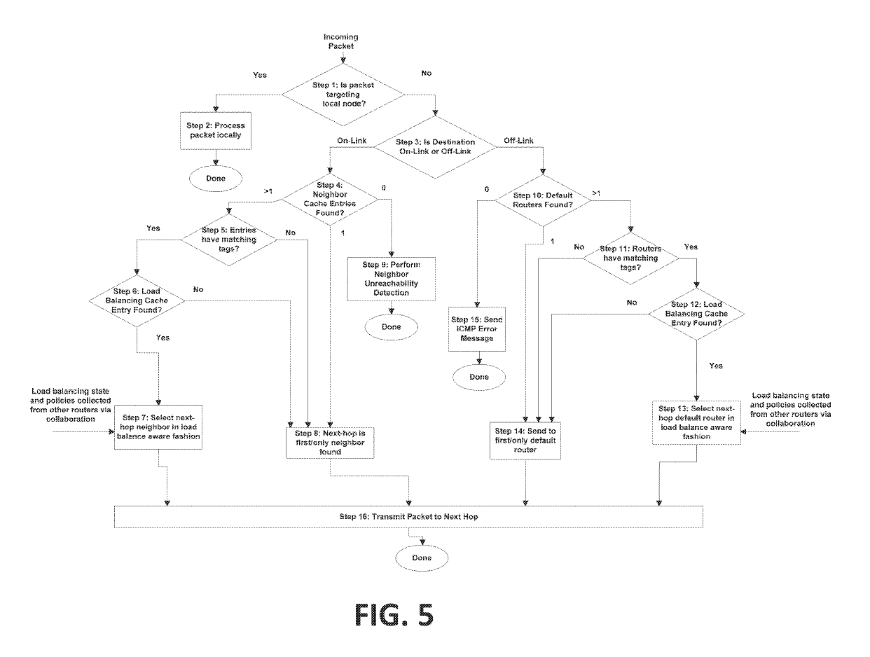

According to a further embodiment, load balancing enhancements to the ND Next-Hop Determination algorithm are disclosed as shown in FIG. 5. Generally, a node uses the Next-Hop Determination algorithm to send a packet to a destination. This algorithm leverages the functionality supported by the Destination Cache, Default Router List, Neighbor Cache and the Neighbor Unreachability Detection algorithm discussed above to determine the IP address of the appropriate next-hop to forward a packet. The results of Next-Hop Determination computations are generally saved in the Destination Cache. When a node has a packet to send, it first examines the Destination Cache. If no entries exist for the destination, Next-Hop Determination is invoked to determine the IP address of the next-hop to forward a packet to. The Next-Hop Determination algorithm compares the prefix portion of the packet's destination IP address to determine if the destination is on-link or off-link. A destination address is on-link if the destination is a single hop away. That is, the next-hop IP address is the destination address of the packet. On the other hand, a destination is off-link if the destination is more than a single hop away. In other words, the next-hop IP address is a next-hop router (selected from the ND default router list). Upon determining the next-hop IP address, the ND Neighbor Cache is consulted for link-layer address information. In addition, the next-hop IP address is also stored in the Destination Cache so that it can be used to service future packets without having to perform the Next-Hop Determination algorithm.

According to one aspect, the following methodologies for load balancing may be performed by the algorithm. One methodology includes factoring the load balancing requirements and state of each node within the load balancing group into its next-hop decision making. In this step, individual node-specific load balancing requirements and state can be maintained in the individual neighbor cache entries and can be dynamically updated via ND message exchanges. Another methodology may include factoring the load balancing policies and state of the load balancing group into its next-hop decision making. In this step, the load balancing policies and state of a load balancing group can be maintained in the ND Load Balancing Cache. In even another methodology, the algorithm may keep track of load balancing decisions regarding the next-hop to forward a packet within the corresponding ND Load Balancing Cache entry. Accordingly, the algorithm can leverage this state when making future load balancing decisions for the group.

As illustrated in FIG. 5, the node determines whether the packet is targeting a local node (step 1). If so, the packet is processed locally, and a next-hop determination is not required (step 2). Otherwise, the node determines whether the target destination is an ‘On-Link’ or ‘Off-Link’ (step 3). As discussed above, the determination is made by comparing the subnet portion of the IP address to the target node's subnet. If the subnet is the same, the next-hop is ‘On-Link’. Otherwise the next-hop is ‘Off-Link’.

If the target destination is an ‘On-Link’, the Neighbor Cache is searched to find all neighboring nodes that may be candidates for targeting as the next-hop for the packet (step 4). This search can be based on a specified targeted anycast IP address in the packet being processed. Notably the Neighbor Cache can store entries for all neighboring nodes having the same anycast IP address. Alternatively, this search can be based on a targeted NDLoadBalancingTag specified in the packet being processed. The ND protocol can support load balancing across groups of nodes that do not require use of an anycast address, but instead can each have their own unique unicast address. Therefore the ND protocol can support load balancing for both anycast IP addressing as well as unicast IP addressing via the use of the NDLoadBalancingTag.

If multiple Neighbor Cache entries are found, then this is an indication of a possible load balancing opportunity. If only an anycast IP address was used to find the Neighbor Cache entries, then the NDLoadBalancingTag fields of all entries are compared with one another (step 5). If matching tags are found (e.g., pattern or string matching is performed on the tags to determine if they match one another), then this is a further indication of a potential load balancing opportunity and the algorithm then determines whether a ND Load Balancing Cache entry was found (step 6). Otherwise, if no matching tags are found, then the algorithm performs no load balancing and selects a next-hop (step 8). That is, the first or only neighbor found is selected.

A lookup to the ND Load Balancing Cache is performed using the NDLoadBalancingTag as an index. If a match is found, then this is an indication that a load balancing group associated with the targeted NDLoadBalancing tag is active and the algorithm subsequently selects the next-hop neighbor in load balance aware fashion based upon load balancing information stored in the ND Neighbor Cache entries, ND Load Balancing Cache entry, and load balancing information collected from other routers (step 7). Otherwise, if no match is found, then the algorithm performs no load balancing and the packet is handled in a non-load balanced fashion whereby the packet is forwarded to the first node found in the Neighbor Cache (step 8).

If no entries are found according to Neighbor Cache determination, then the ND Neighbor Unreachability Detection algorithm is invoked to see if a neighbor can be discovered (step 9).

Assuming ‘Off-Link’, the ND Default Router List is searched to find available default routers (step 10). If more than one default router is found the algorithm subsequently determines if routers have matching tags (step 11). If only one default router is found, the algorithm determines that the packet should be sent to the first or only default router (step 14), and is then sent thereto (step 16). If no default routers are found, an ICMP error message is sent (step 15).

On the other hand, if multiple Default Router List entries are found (step 10), a possible load balancing opportunity is discovered. The NDLoadBalancingTag fields of all the default router entries found are compared with one another. If matching tags are found, a further indication of a potential load balancing opportunity is realized (step 11). A lookup to the ND Load Balancing Cache is performed using the NDLoadBalancingTag as an index (step 12). If a match is found, then this is an indication that a load balancing group associated with the targeted NDLoadBalancing tag is active and the algorithm proceeds to step 13.

Otherwise, if no match is found, the the algorithm performs no load balancing and the packet is handled in a non-load balanced fashion (e.g., packet is forwarded to the first default router found in the list) (steps 14 and 16).

The node uses load balancing information stored in the ND Default Router List, ND Load Balancing Cache entry, and load balancing information collected from other routers via collaboration to determine the next hop router to forward the packet to in a load balanced aware fashion (step 13). In this case, load balancing state and policies are collect from other routers via collaboration.

### Creating a ND Load Balancing Group

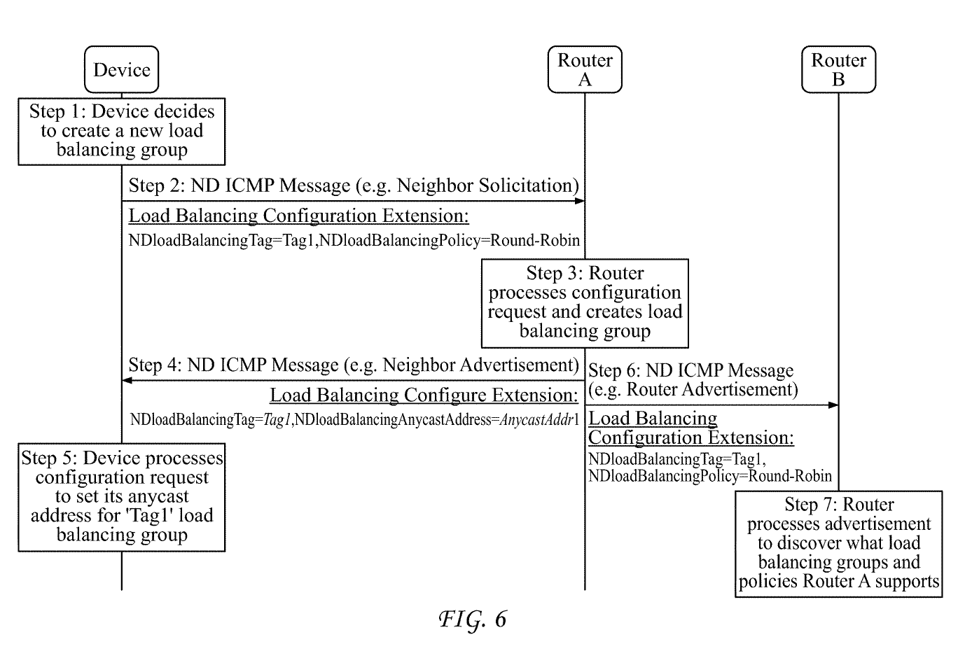

According to yet another aspect of the application, there is disclosed a method of creating a ND load balancing group by a node. In one embodiment, the load balancing group is created by an endpoint device as shown in FIG. 6 (Step 1). Generally, when an endpoint device decides to create a load balancing group, the group is created on its default registered router. The endpoint device may have been programmed upon start-up to create a load balancing group. Alternatively, the endpoint device may discover similar devices with the same advertised tag value on the same default registered router. As shown in FIG. 6, the endpoint device may send a ND ICMP message—NS—to its default router (Step 2).

The message to the default router may include a load balancing configuration extension with a load balancing tag name and policy. Upon receipt and review of the configuration request, the default router may process it (Step 3). The processing of the request includes but is not limited to parsing the load balancing configuration extension contained within the ND ICMP message to determine desired load balancing group and/or load balancing requirements of the device. The router determines whether to approve creation of the load balancing group based upon various dynamic factors such as whether or not the router has available resources to manage additional load balancing groups. Alternatively, this decision can be based upon administrative policies controlling which devices or types of devices are permitted to create load balancing groups. The router may also choose to decline the request if it is unable or unwilling to manage the load balancing group.

Assuming the default router accepts the request, it creates a load balancing group by creating a new entry in the router's ND Load Balancing Cache. Then, the default router sends a ND ICMP Message—NA—with a load balancing configuration extension that includes an anycast address for configuration on the endpoint device (Step 4).

Upon receipt of the ND ICMP message, the endpoint device may process it and then configure its anycast address accordingly (Step 5). By so doing, the endpoint device is able to receive and process packets from the router targeting the specific anycast address. Alternatively, the endpoint device, after creation of the load balancing group, may opt not to join.

In a further embodiment, the default router may also share load balancing information with another router, e.g., Router B (Step 6). To do so, the default router, e.g., Router A, sends a ND ICMP Message—RA—to Router B. For example, load balancing information may include the load balancing groups currently managed by Router A, the devices that are currently members of the group, the anycast address associated with the group, load balancing policies associated with the group, etc. Router B discovers what load balancing groups and policies are supported by Router A by analyzing ND ICMP message (e.g., Router Advertisement) it receives (Step 7). Router B can use this information when receiving packets that target the address associated with the load balancing group. By using this information, Router B can also make load balancing aware routing decisions in addition to Router A.

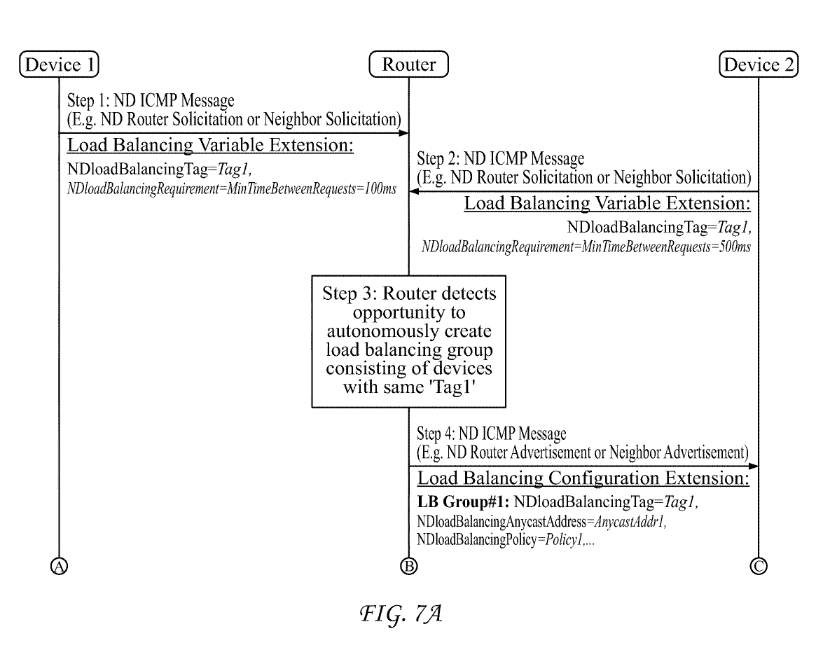

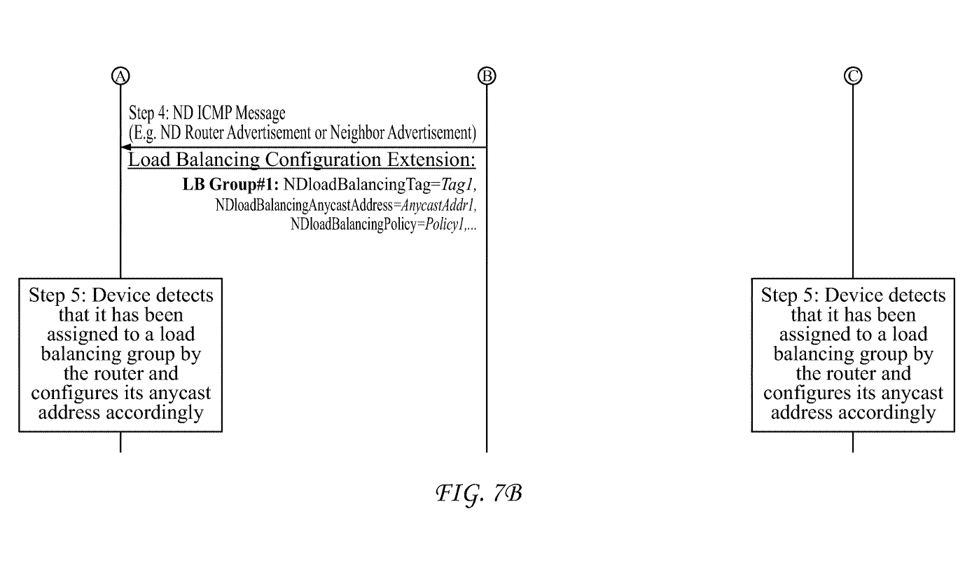

According to another embodiment, a router may create a load balancing group upon detecting that at least two nodes have expressed interest in belonging to a load balancing group. For example, as shown in FIG. 7, a first node, preferably an endpoint device, sends a ND ICMP message—RS or NS—that includes its load balancing variable extension and information such as a load balancing tag and load balancing requirements of the device (Step 1). The load balancing requirement may include, but is not limited to, the minimum time between packet transmission, and minimum/maximum packet size). A second node, preferably a second endpoint device sends a ND ICMP message similar to that sent by the first node discussed above (Step 2). A router detects that at least two devices in the network with the same load balancing tag have expressed interest in belonging to a load balancing group (Step 3). An opportunity for the router may therefore exist to create a load balancing group. Alternatively, a router could actively seek devices with similar tags and then autonomously create a load balancing group by sending a RS or NS.

After the router forms a load balancing group, a ND ICMP message—NA or RA—with a load balancing configuration extension is sent to the devices (Step 4). The one or more devices process the message from the router, detects it has been assigned to a load balancing group, and preferably configures its anycast address accordingly (Step 5).

On the other hand, a node—endpoint device or router—may opt not to join the load balancing group created by the router. This could be attributed to many reasons including, for example, packet sizes and time for forwarding.

### Discovering and Joining ND Load Balancing Group(s)

According to yet even another aspect of the present application, there is disclosed a method for a node to discover and join a ND load balancing group. In one embodiment, the load balancing group is discovered and joined by an endpoint device. In another embodiment, the load balancing group is discovered and joined by a router.

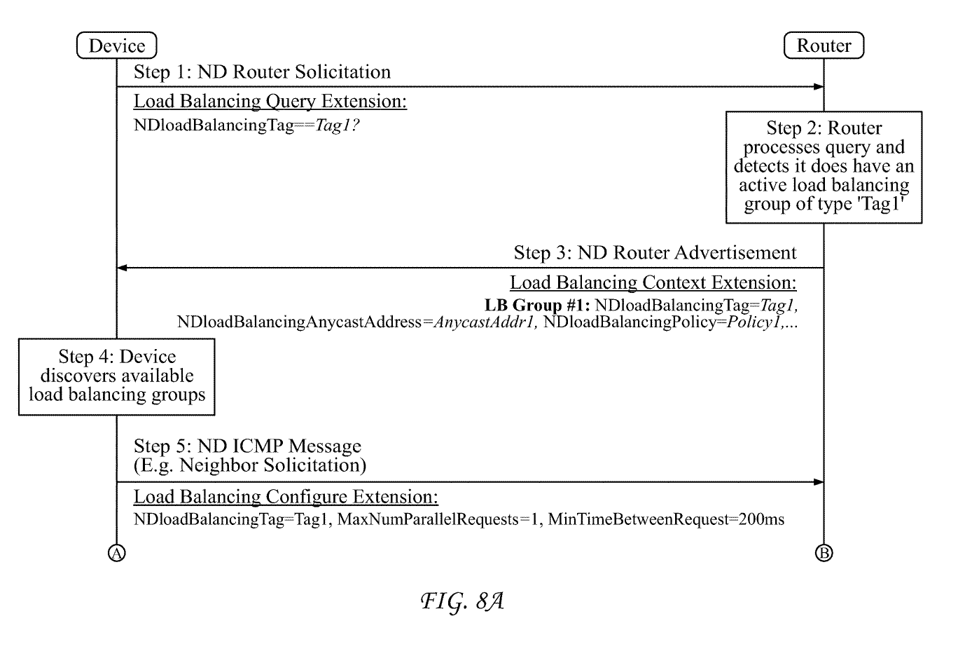

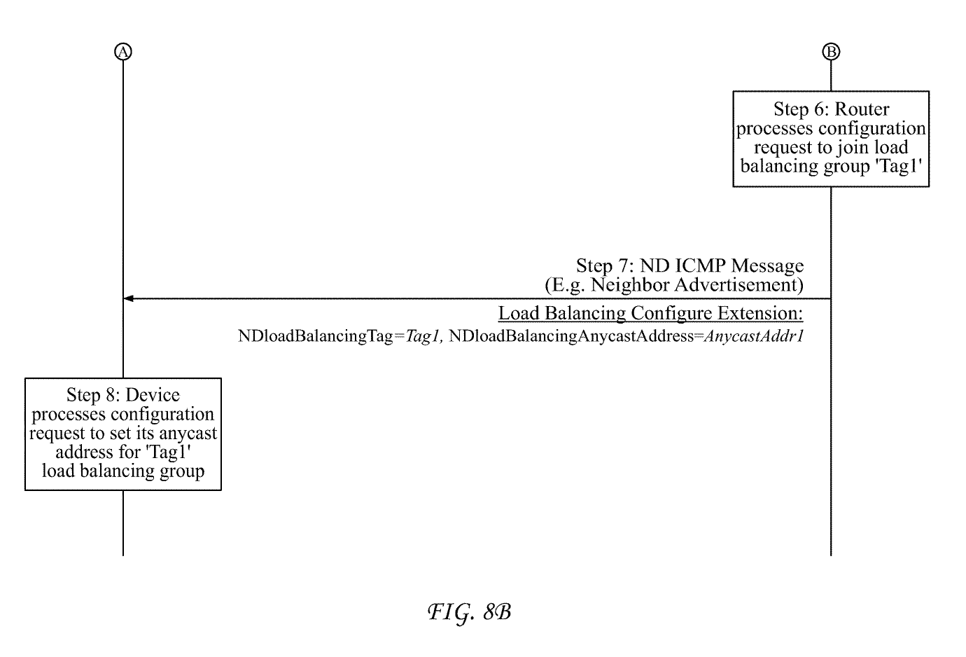

According to one embodiment, an endpoint device may solicit a router for available load balancing groups as shown in FIG. 8. The endpoint device sends a RS containing a load balancing query extension (Step 1). The load balancing query extension includes a query string to inquire upon the router whether it supports a load balancing group with a corresponding tag name. In an alternative embodiment, the device could specify a list of load balancing requirements/features that it requires from the load balancing group. For example, the endpoint device may wish to join a group with a specific policy on guaranteed minimum time between requests. The endpoint device may also wish to join a group with a specific policy on packet size.

Next, the default router receives and processes the load balancing query request (Step 2). The router then determines whether it manages a load balancing group with the specified tag name provided by the endpoint device in addition to any other specific requirements noted above.

If the router detects that it has a balancing group with the appropriate tag, e.g., Tag 1, it may send a ND RA message including a load balancing context/variable extension to the endpoint device (Step 3). Within this extension, the router includes information regarding the load balancing group that was queried. For example, information such as load balancing group tag name, anycast address, and policy may be provided. Alternatively, if the default router does not have a load balancing group, it may refrain from replying to the device. In another alternative, the default router may reply with a message indicating it does have a load balancing group and/or of the type requested. This extra step may provide the device with an awareness of the router's features.

Next, the endpoint device receives ND RA and discovers available load balancing groups on the router (Step 4). If the endpoint device decides that it would like to join this group, it sends a ND ICMP message—NS—that includes a load balancing configuration extension. The decision to join may be based upon several factors including but not limited to detection of an existing load balancing group compatible with the device. Compatibility may be based upon the same make and model of devices, same type of device, or some other criteria. In one embodiment, this detection can be performed by the device querying a router when it joins the network to get a list of the available load balancing groups (e.g., each group can be identified via a unique NDLoadBalancingTag variable). Within this extension, the device specifies the load balancing group tag name that it would like to join as well as some load balancing requirements. The tag requirements may include, for example, maximum number of parallel requests, minimum time between requests, or some other criteria.

Thereafter, the router receives the ND ICMP message and processes the request to join the specified load balancing group (Step 5). The request is processed by parsing the load balancing configuration extension to determine desired load balancing group and/or load balancing requirements of the device (Step 6). Then, the router determines whether or not to approve adding the device to the load balancing group. This determination can be based on dynamic context such as whether or not the router has available resources to manage additional load balancing group members. Alternatively, this decision may be based on administrative policies controlling which devices or types of devices are permitted to join the group.

Upon the router approving the request, the router sends a ND ICMP message—NA—containing a load balancing configuration extension to the endpoint device (Step 7). Within this extension, an anycast address is provided that the Router wishes to configure the endpoint device to in the load balancing group.

The endpoint device receives the message and configures its anycast address accordingly (Step 8). In doing so, the device is able to receive packets from the router targeting the anycast address.

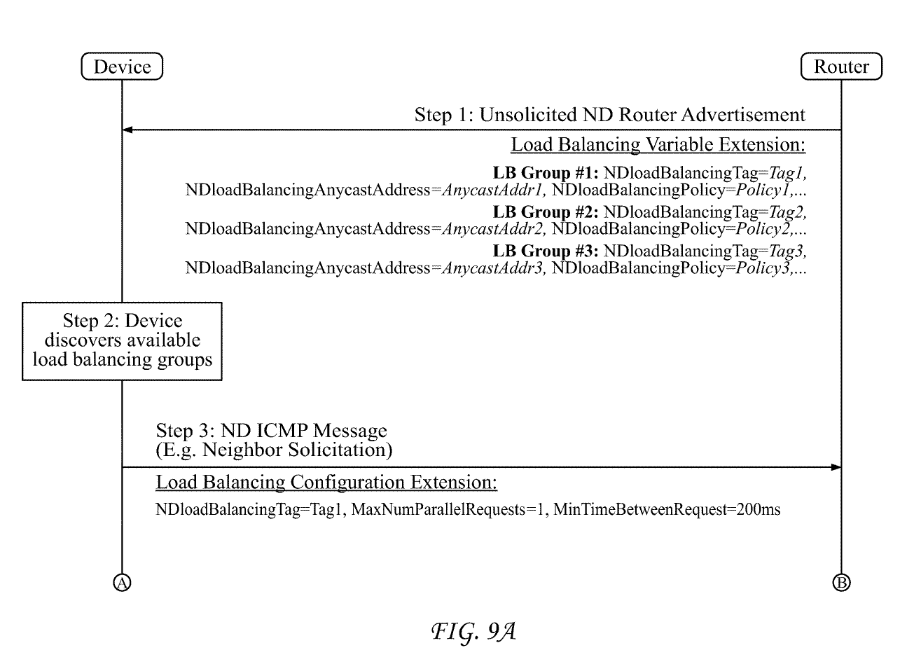

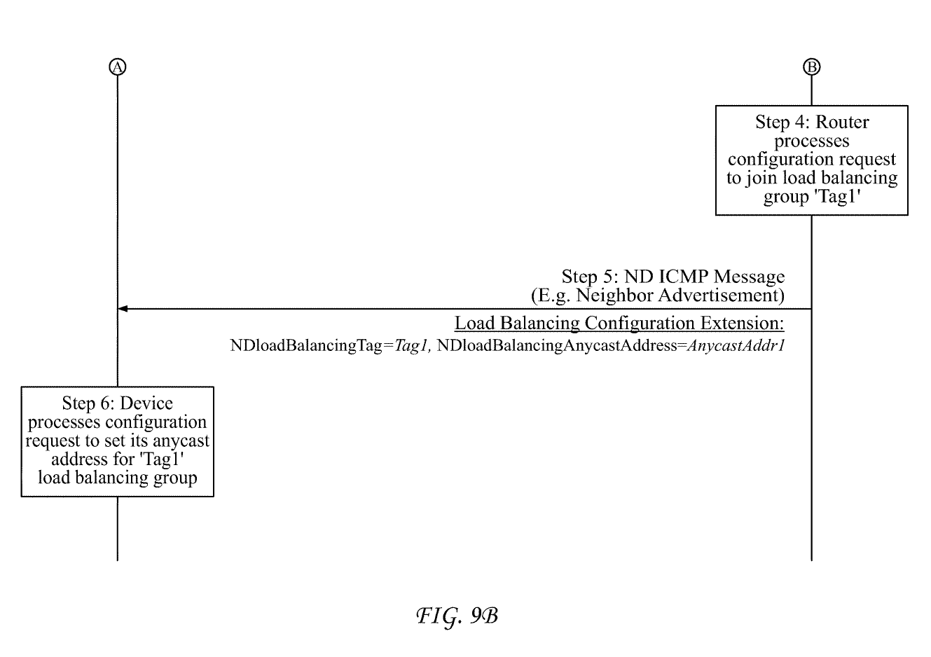

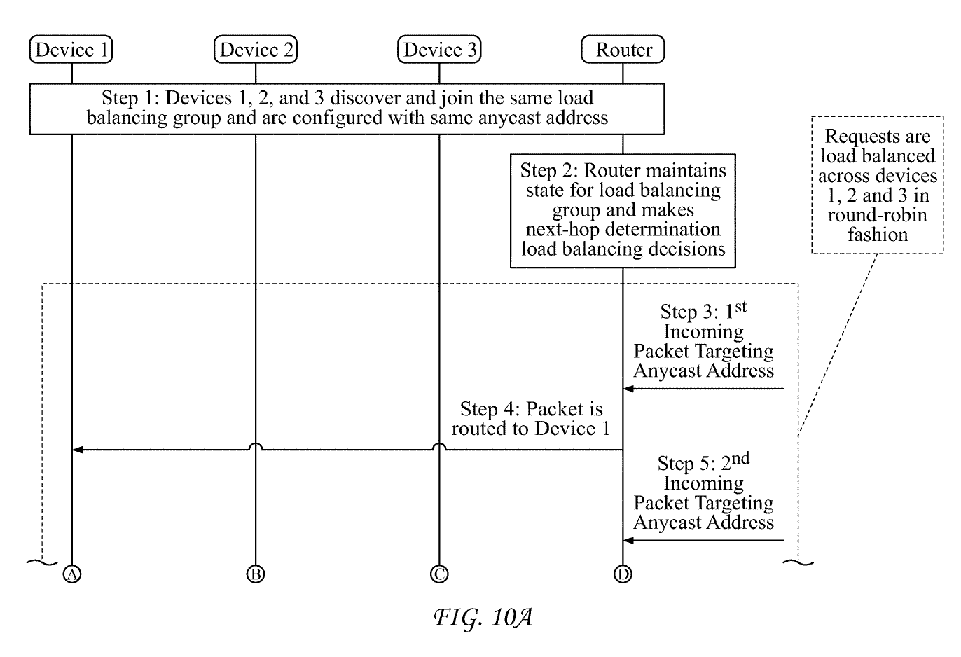

In accordance with another aspect of this application, a router may send an unsolicited ND RA message including a load balancing variable extension as shown in Step 1 of FIG. 9. The router may include information regarding the load balancing groups that it is managing, such as for example, load balancing group tag names, anycast addresses, and policies.

An endpoint device may receive an unsolicited ND RA and then discovers available load balancing groups by parsing the load balancing variable extensions contained within the ND RA message (Step 2). The endpoint device may decide to join one of these groups. It may do so by sending a ND ICMP message—NS—including a load balancing configuration extension (Step 3). Within this extension, the device specifies the load balancing group tag name—NDLoadBalancingTag variable—that it would like to join as well as some load balancing requirements. The decision to join a load balancing group may be based on several factors including, for example, detection of an existing load balancing group compatible with the device. Compatibility may include the same make and model of devices, same type of device, and other criteria.

Next, the router receives and processes the device's request to join the specified load balancing group by parsing the load balancing configuration extension contained within the ND ICMP message to determine desired load balancing group and/or load balancing requirements of the device (Step 4). As discussed above, the router determines whether to approve adding the device to the load balancing group. This may be based on dynamic context such as whether or not the router has available resources to manage additional load balancing group members. Alternatively, this decision can be based on administrative policies controlling which devices or types of devices are permitted to join the group.

If the router approves the request, it returns an ND ICMP message—NA—containing a load balancing configuration extension (Step 5). Within this extension the router defines an anycast address that it wishes to configure the device with such that it is included in the load balancing group. The endpoint device receives the message and may configure its anycast address accordingly (Step 6).

### Forwarding Packets in Load Balanced Manner

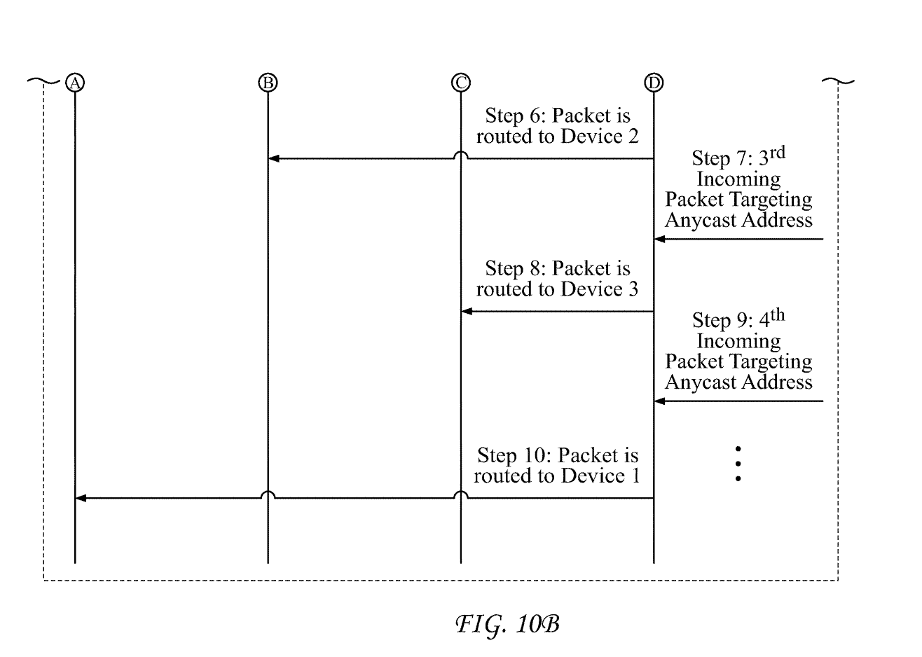

According to a further aspect of this application there is disclosed a method for forwarding packet in a load balanced manner as shown in FIG. 10. A router managing a common load balancing group includes plural nodes configured with the same anycast address of the group. As shown in FIG. 10, there are three devices, preferably endpoint devices, which discovered and joined the same load balancing group (Step 1). The router maintains state for this load balancing group (Step 2). The router uses this state as an input to its load balance aware ND Next-hop Determination algorithm discussed above and as illustrated in FIG. 5. Maintaining this state can be done via the router querying devices for load balancing state (e.g., via ND ICMP message containing load balancing query extensions) or devices publishing load balancing state (e.g., via ND ICMP messages containing load balancing configuration extensions). The router may use this algorithm to load balance incoming packets targeting the anycast address using a round-robin policy. Other policies may also be employed here such as weighted round robin or energy aware round robin.

The Router may receive one or more packets for routing targeting an Anycast Address (Steps 3, 5, 7 and/or 9). The router may route the first incoming packet to Device 1, based upon the load balancing state information and policies the router maintains for each of the load balancing groups it manages. This is achieved by first inspecting the IP address contained in the IP datagram header. It then uses this address to index into its load balancing groups. Upon finding a matching load balancing group, the load balancing state and policies of this group are employed to determine the device to route this request. The router determines to route it to Device 1 (Step 4). Thereafter, the router updates its load balancing state to keep track that it routed the last packet for this group to Device 1.

Next, the router routes the second incoming packet to Device 2 (Step 6). It does this by first inspecting the IP address contained in the IP datagram header. It then uses this address to index into its load balancing groups. Upon finding a matching load balancing group, load balancing state and policies of this group are employed to determine the device to route this request. Here, the router determines to route it to Device 2 since it routed the last packet to Device 1, employing round robin. It then updates it load balancing state to keep track that it routed the last packet for this group to Device 2.

Thereafter, the router routes the third incoming packet to Device 3 (Step 8). It does this by first inspecting the IP address contained in the IP datagram header. It then uses this address to index into its load balancing groups. Upon finding a matching load balancing group, the load balancing state and policies of this group are employed to determine the device to route this request. Here, the router determines to route it to Device 3 since it routed the last two packets to Devices 1 and 2. It then updates it load balancing state to keep track that it routed the last packet for this group to Device 3.

Even further, the router routes the fourth incoming packet targeting the anycast address to Device 1 (Step 10). Upon finding a matching load balancing group, the load balancing state and policies of this group are used to determine the device to route this request to. In this case, the router determines to route the packet to Device 1 since it routed the last two packets to Devices 2 and 3. It then updates its load balancing state to keep track that it routed the last packet for this group to Device 1.

According to the present application in even a further embodiment, it is understood that any or all of the systems, methods and processes described herein may be embodied in the form of computer executable instructions, e.g., program code, stored on a computer-readable storage medium which instructions, when executed by a machine, such as a computer, server, M2M terminal device, M2M gateway device, or the like, perform and/or implement the systems, methods and processes described herein. Specifically, any of the steps, operations or functions described above may be implemented in the form of such computer executable instructions. Computer readable storage media include volatile and nonvolatile, removable and non-removable media implemented in any method or technology for storage of information, but such computer readable storage media do not includes signals. Computer readable storage media include, but are not limited to, RAM, ROM, EEPROM, flash memory or other memory technology, CD ROM, digital versatile disks (DVD) or other optical disk storage, magnetic cassettes, magnetic tape, magnetic disk storage or other magnetic storage devices, or any other physical medium which can be used to store the desired information and which can be accessed by a computer.

According to yet another aspect of the application, a non-transitory computer-readable or executable storage medium for storing computer-readable or executable instructions is disclosed. The medium may include one or more computer-executable instructions such as disclosed above in the plural call flows according to FIGS. 5-10. The computer executable instructions may be stored in a memory and executed by a processor disclosed above in FIGS. 1C and 1D, and employed in devices including but not limited to IoT devices, routers, and gateways within LAN/PAN networks. In one embodiment, a computer-implemented device having a non-transitory memory and processor operably coupled thereto, as described above in FIGS. 1C and 1D, is disclosed. Specifically, the non-transitory memory has instructions stored thereon for creating a load balancing group. The processor is configured to perform the instructions of: (i) sending a ND ICMP message to the router including a load balancing configuration extension; and (ii) receiving a ND ICMP message from the router including an anycast address related to the load balancing configuration extension.

According to even another embodiment, the non-transitory memory has instructions stored thereon for discovering a load balancing group. The processor is configured to perform the instructions of: (i) providing a node and a router; (ii) sending a solicitation to a router including a load balancing query extension; and (iii) receiving a load balancing context extension RA including available load balancing groups. According to yet even a further embodiment, the processor is configured to perform the instructions of (i) receiving a load balancing variable extension including a load balancing group from the router; and (ii) determining whether to join the load balancing group.

While the methods, systems and software applications have been described in terms of what are presently considered to be specific aspects, the disclosure need not be limited to the disclosed aspects. It is intended to cover various modifications and similar arrangements included within the spirit and scope of the claims, the scope of which should be accorded the broadest interpretation so as to encompass all such modifications and similar structures. The present disclosure includes any and all aspects of the following claims.

What is claimed is:

1. An endpoint device comprising:
a non-transitory memory having instructions stored thereon for creating a load balancing group; and
a processor, operatively coupled to the memory, the processor configured to perform the instructions of: (i) sending a ND ICMP message to a router including a load balancing configuration extension; and (ii) receiving a ND ICMP message from the router including an anycast address related to the load balancing configuration extension.

2. The device of claim 1, further comprising:
a transceiver.

3. The device of claim 1, wherein the processor configures the anycast address in order to receive packets from the router targeting the anycast address.

4. The device of claim 1, wherein the load balancing configuration extension is selected from a load balancing tag, a load balancing anycast address, a load balancing unicast address, a load balancing requirement, a load balancing policy, a load balancing state, and combinations thereof.

5. The device of claim 1, wherein the processor is further configured to route packets to the router in the load balancing group after the receiving step.

6. The device of claim 1, wherein the processor is further configured to autonomously detect the router including the load balancing configuration extension.

7. A computer-implemented method of creating a load-balancing group comprising:
determining to create a load balancing group on a router;
sending a ND ICMP message to the router including a load balancing configuration extension; and
receiving a ND ICMP message from the router including an anycast address related to the load balancing configuration extension.

8. The method of claim 7, further comprising:
configuring the anycast address in order to receive packets from the router targeting the anycast address.

9. The method of claim 7, wherein the load balancing configuration extension is selected from a load balancing tag, a load balancing anycast address, a load balancing unicast address, a load balancing requirement, a load balancing policy, a load balancing state, and combinations thereof.

10. The device of claim 7, further comprising:
routing packets to the router in the load balancing group after the receiving step.

11. A computer-implemented method of discovering a load balancing group comprising:
providing a node and a router;
receiving a load balancing variable extension including a load balancing group from the router; and
determining whether to join the load balancing group.

12. The method of claim 11, further comprising:
sending a message including a load balancing configuration extension to the router.

13. The method of claim 12, further comprising:
receiving a ND ICMP message from the router including an anycast address.

14. The method of claim 13, further comprising:
configuring the anycast address in order to receive packets from the router targeting the anycast address.

15. The method of claim of 11, further comprising:
routing packets to the router in the load balancing group after the receiving step.

16. A computer-implemented method of discovering a load balancing group comprising:
providing a node and a router;
sending a solicitation to a router including a load balancing query extension; and
receiving a load balancing context extension RA including available load balancing groups;

17. The method of claim 16, further comprising:
determining whether to join the available load balancing groups;

18. The method of claim 16, further comprising:
sending a load balancing configuration extension; and
receiving a ND ICMP message from the router including an anycast address related to the load balancing configuration extension.

19. The method of claim 16, further comprising:
sending a message to the router with load balancing details of which load balancing group to join.

20. The method of claim 16, further comprising:
routing packets to the router in the load balancing group.
